(19) United States
(12) Patent Application Publication
(10) Pub. No.: US 2026/0064555 A1
(43) Pub. Date: Mar. 5, 2026

(54) METHOD FOR IDENTIFYING ERRORS IN THE INTEGRATION OF SERVICE COMPONENTS IN A SYSTEM BASED ON A SYSTEM-SPECIFIC ERROR TAXONOMY, CONTROL DEVICE, COMPUTER PROGRAM AND ELECTRONICALLY READABLE DATA CARRIER

(71) Applicant: Siemens Aktiengesellschaft, München (DE)

(72) Inventors: Anja Hentschel, München (DE); Horst Sauer, München (DE); Lena Gregor, Neubiberg (DE)

(21) Appl. No.: 19/315,971

(22) Filed: Sep. 2, 2025

(30) Foreign Application Priority Data
Sep. 4, 2024 (EP) 24198403.8

(51) Int. Cl. G06F 11/34; G06F 11/07

(52) U.S. Cl. CPC G06F 11/3409; G06F 11/0766

(57) ABSTRACT

Identifying integration errors in the integration of service components in a system based on a system-specific integration error taxonomy by a test device, wherein the test device stores a basic integration error taxonomy that defines integration error classes, wherein the respective integration error classes are assigned respective integration error types, including steps performed by the test device: performing an assignment method, wherein at least some of the integration error types in the basic integration error taxonomy are assigned respective integration error detection methods; receiving system information about the system; performing a specialization method, wherein a system-specific integration error taxonomy for examining the system depending on the system information is generated based on the basic integration error taxonomy; performing a selection method, wherein at least some of the integration error types in the system-specific integration error taxonomy are assigned respective ones of the integration error detection methods depending on system information.

### CROSS REFERENCE TO RELATED APPLICATIONS

This application claims priority to EP Application Serial No. 24198403.8, having a filing date of Sep. 4, 2024, the entire contents of which are hereby incorporated by reference.

### FIELD OF TECHNOLOGY

The following relates to a method for identifying integration errors in the integration of service components in a system based on a system-specific integration error taxonomy, to a test device configured to perform a method for identifying integration errors in a system based on a system-specific integration error taxonomy, to a computer program and to an electronically readable data carrier.

### BACKGROUND

In recent years, the trend toward using service components in the industrial context has become prevalent, with microservices and macroservices and also other components with a service character being used. The terms “system” and “service component” are defined as follows.

A system consists of software components and hardware components, including a collection of “service components”. A service component is characterized by individual business capabilities that distinguish it from other service components. It may be provided, installed/employed and executed individually. Communication with other components of embodiments of the system takes place via lightweight synchronous or asynchronous mechanisms such as REST APIs, message queues or industry-specific protocol stacks. Service components may be distributed and scalable.

It may be observed, in the development and operation of systems with service components, that tests on individual service components are mastered well by established test methods and (agile) teams take responsibility for the component. However, there are increasingly major problems when integrating these service components, and systematic approaches are often lacking. New sources of integration errors arise through the use of unfamiliar methods and technologies such as DevOps, cloud or asynchronous communication. Integration errors during operation are difficult to foresee, in particular due to the typically emergent behavior of service components. Proven methods with regard to test design and determining test coverage for integration tests are not available. Existing integration error taxonomies for monolithic or object-oriented systems are insufficient, since for example aspects of distribution and integration into the execution environment (infrastructure, target environment) are not taken into account.

The test methods for the integration of systems with service components may be divided into experience-based or somewhat random methods. However, these methods are often insufficient to take into account all potential sources of integration errors and ensure that embodiments of the system is functioning in error-free fashion.

Existing integration error taxonomies are not always helpful for classifying integration errors when integrating systems with service components. The prior art is often outdated and relates for example to earlier architectures such as SOA or conventional software systems that are covered in literature and research.

In embodiments, the systems in question are often systems with a mixture of software components and hardware components. Available taxonomies often do not take this into account, thereby limiting their applicability.

In addition, available integration error taxonomies are not always applicable to today's architectures such as microservice-based systems or Internet of Things (IoT) systems. These modern architectures require a more specific approach to classifying and analyzing integration errors that is not taken into account in existing taxonomies.

### SUMMARY

An aspect relates to a method for identifying integration errors in a system. An aspect of embodiments of the invention is in particular to provide the method for service-based systems in order to be able to identify the specific integration errors that occur during integration in the service-based systems.

Embodiments of the present invention aim to address these challenges by providing a method for classifying and analyzing integration errors in systems with service components. Fields of application include all fields that develop systems with service components, such as highly complex modular projects in the DevOps context, for example plant control, grid control, platforms for the operation and control of railway infrastructure, platforms for digital services in hospitals, and operation and monitoring of building technology.

Embodiments of the invention provide a systematic approach for the purpose of finding integration errors in the integration of service components and of making a quantified assessment of the correctness of the functionality of embodiments of the system on this basis. The basis is a predefined integration error taxonomy that is able to be adapted to embodiments of the system and its application context.

A first aspect of embodiments of the invention relates to a method for identifying integration errors in the integration of service components in a system based on a system-specific integration error taxonomy by way of a test device. In embodiments, the system may in particular be a control device or a group of control devices that are configured to operate service components, for example microservices, and/or the service components themselves. A basic integration error taxonomy is stored in the test device. The basic integration error taxonomy defines integration error classes, wherein respective integration error types are assigned to the respective integration error classes. The integration error types concern potential integration errors that may occur in embodiments of the system. The integration error types are grouped into the integration error classes.

In embodiments, the method comprises the following steps that are carried out by the test device.

A first step comprises receiving a method list. In embodiments, the method list comprises provided integration error detection methods that are able to be applied by the test device for the purpose of detecting integration errors in embodiments of the system. Provision is made for the respective integration error detection methods to be assigned the integration error types that are able to be identified by the respective integration error detection method. In other words, the test device is configured to apply the integration error detection methods in order to identify the integration error types assigned to the integration error detection methods in embodiments of the system. The provided integration error detection methods are provided in embodiments of the method list. Providing embodiments of the method list makes it possible to provide the test device with an up-to-date status of the integration error detection methods.

A further step comprises performing an assignment method by way of the test device. In the assignment method, at least some of the integration error types in the basic integration error taxonomy are assigned respective ones of the integration error detection methods. In other words, the basic integration error taxonomy comprises the integration error classes and the integration error types that may occur in embodiments of the system and whose presence is to be checked by the test device. In order to identify the integration errors described in the basic integration error taxonomy, it is necessary to assign the relevant integration error detection methods to the integration errors. For this purpose, the test device determines which of the integration error detection methods in the method list is configured to identify the relevant integration errors and assigns the respective integration error detection method to the relevant integration error types in the basic integration error taxonomy. In embodiments, the method list may for example assign the relevant integration error types to the respective integration error detection methods in meta-information, so that the test device is able to assign the integration error detection methods in the basic integration error taxonomy based on the meta-information. The assignment thus enables the test device to identify the relevant integration errors in embodiments of the system by way of the assigned integration error detection methods, based on the basic integration error taxonomy. However, the basic taxonomy is non-specific, which means that it describes a general approach to integration error identification, without addressing embodiments of the system to be tested individually.

In order to provide a taxonomy for testing a specific system based on the basic integration error taxonomy, a further step of embodiments of the method comprises receiving system information about the system to be checked. In embodiments, the system information may comprise for example information about hardware modules and/or software modules of the system, along with their version. The test device is configured to determine, based on the system information, which of the integration error types described in the basic integration error taxonomy are relevant for the system to be tested and therefore need to be tested.

In order to align the basic integration error taxonomy with the specific system, embodiments of the method comprises a specialization method that is performed by the test device. The specialization method comprises determining a system-specific integration error taxonomy in order to examine embodiments of the system. In embodiments, the system-specific integration error taxonomy is based on the basic integration error taxonomy. In other words, relevant integration error types that are described in the basic integration error taxonomy are used to create the system-specific integration error taxonomy, depending on the system information. In embodiments, the system-specific integration error taxonomy is generated here depending on the system information describing the system to be examined. In embodiments, the system-specific integration error taxonomy may be a taxonomy that comprises only the integration error types and integration error classes of the basic integration error taxonomy that are relevant for the examination of the system described by the system information.

In addition to the integration error types, the integration error detection methods to be applied may also depend on embodiments of the system described by the system information. For this reason, a further step of embodiments of the method comprises performing a selection method. In the selection method, at least some of the integration error types in the system-specific integration error taxonomy are assigned respective ones of the integration error detection methods that are assigned to the integration error types in the basic integration error taxonomy depending on embodiments of the system information. One example may be that multiple suitable integration error detection methods for detecting the integration errors are assigned to a specific integration error type in the basic integration error taxonomy. Depending on embodiments of the system information, at least some of the integration error detection methods in the basic integration error taxonomy are selected and assigned to the system-specific integration error taxonomy. One example may be that some of the integration error detection methods in embodiments of the system are not suitable or not compatible with embodiments of the system as per the system information. Accordingly, the suitable integration error detection methods may be selected depending on the system information. After the selection method is complete, the system-specific integration error taxonomy is provided to examine the system. In embodiments, the system-specific integration error taxonomy comprises the integration error types and integration error classes relevant for the system, and also the integration error detection methods relevant for the system for detecting the relevant integration error types.

A further step comprises examining embodiments of the system in accordance with the system-specific integration error taxonomy by way of the test device. In other words, the test device examines embodiments of the system, wherein the integration error types listed in the system-specific integration error taxonomy are checked with regard to whether they are present by way of the assigned integration error detection methods. Examining embodiments of the system comprises generating an integration error log, wherein the integration errors found in the system by the integration error detection methods are logged.

In a further step, provision is made for embodiments of the system to be assessed by the test device based on the integration error log. By way of example, the assessment may depend on a quantity of the integration errors found and/or a quality of the integration errors found.

In a further step, the test device outputs an output signal that comprises the assessment of embodiments of the system carried out by the test device. By way of example, the output signal may be intended to enable or disable embodiments of the system depending on the assessment.

One development of embodiments of the invention makes provision for the method to comprise receiving application information about an application of the system by way of the test device. In other words, in addition to the system information concerning the system, the test device also receives application information relating to the application of embodiments of the system.

Provision is made for the specialization method to generate the system-specific integration error taxonomy of embodiments of the system to be examined depending on the application information. In other words, in addition to the system information, the application information is also taken into account in order to generate the system-specific integration error taxonomy intended to test embodiments of the system. The application information may describe for example an application context and/or a target environment of embodiments of the system in which the service components are operated. Provision may therefore be made for the system-specific integration error taxonomy to be provided both based on the system and based on the application context. Provision may be made here to add only the integration error types that are relevant both for embodiments of the system and for the application context to the system-specific integration error taxonomy.

The selection method also makes provision for at least some of the integration error types in the system-specific integration error taxonomy to be assigned respective ones of the integration error detection methods from the basic integration error taxonomy depending on the application information. In other words, in addition to the integration error types, the selected integration error detection methods also depend on the application information. Provision is thus made for the integration error detection methods to be assigned to the system-specific integration error taxonomy not only depending on embodiments of the system but also depending on the application context.

This development offers the advantage that the selection of the integration error types is able to be restricted to the specific application case.

One development of embodiments of the invention makes provision for the specialization method to comprise outputting a notification signal describing the relevant integration error types in the system-specific integration error taxonomy. In other words, as part of the specialization method, the system-specific integration error taxonomy that comprises the relevant integration error types for embodiments of the system to be checked is determined. The relevant integration error types that were determined by the test device for the system are output by the test device by way of the notification signal. The output may be given for example to a device that is equipped with a user interface in order to inform a user about the possible integration error types.

One development of embodiments of the invention makes provision for examining the system in accordance with the system-specific integration error taxonomy to comprise outputting an instruction signal in accordance with at least one integration error detection method by way of the test device. In other words, provision is made for the instruction signal to be output by the test device in order to detect the relevant integration error according to the integration error detection method. The instruction signal may be intended for example to instruct a device to check embodiments of the system. This may be necessary for example if the test device is not configured independently to perform the integration error detection method. The instruction signal may comprise for example a list of instructions to be carried out by the device. The instruction signal may also comprise instructions to a user that are able to guide them to set embodiments of the system to a predefined state or to perform certain actions with respect to embodiments of the system. The instruction signal may be output for example to a device configured to examine embodiments of the system. Examining embodiments of the system comprises receiving a result signal by way of the test device. The result signal may comprise results and/or feedback from instructions performed in accordance with the instruction signals. The result signal may be provided by the device addressed in the instruction signal and depend on a user input, for example. In a further step, the results of the result signal are compared with expected values. In other words, the test device determines whether the results match or deviate from expected values. Based on the comparison, the test device identifies that an integration error is present. This development provides the advantage that the test device may be used to perform integration error detection methods requiring the involvement of further devices or a user.

One development of embodiments of the invention makes provision for examining the system to comprise controlling the system in accordance with the integration error detection method by way of the test device. In other words, provision may be made for the test device to be connected directly to embodiments of the system via an interface. The test device is accordingly configured to control embodiments of the system so as to perform the integration error detection methods and/or to retrieve predefined values in accordance with the integration error detection method from embodiments of the system in order to detect the integration error. This development provides the advantage of enabling automatic checking of embodiments of the system by way of the test device.

One development of embodiments of the invention makes provision for examining the system to comprise determining a coverage of the system-specific integration error taxonomy. In other words, provision is made for the test device to determine the coverage describing the extent to which the system has been tested for the integration error types in accordance with the system-specific integration error taxonomy. The coverage may depend on factors such as a number and type of the tests, a quality of the test data, automation and the priority values of the integration error types tested. Provision is made for the coverage to be described in the integration error log and for the assessment of embodiments of the system to be determined depending on the coverage.

One development of embodiments of the invention makes provision for respective integration error types in the system-specific integration error taxonomy to be assigned respective priority values, wherein a sequence of the testing of the integration error types in the system-specific integration error taxonomy depends on their priority values. The priority values are intended to prioritize the relevant integration error categories in the system-specific integration error taxonomy according to their significance to the system for the test method. When assigning the priority values, it may be taken into account which integration error categories are more likely to cause serious problems in the system, or which integration errors have a greater impact on the functionality of the system. The test device may be configured to define a sequence in which the relevant integration error categories in the system-specific integration error taxonomy are run through in the test method in accordance with the priority values. Provision may be made in particular for the integration error categories that have been assigned a higher priority as per their priority value to be checked first.

Prioritization makes it possible to ensure that the limited resources of the test device for identifying integration errors are able to be focused, in targeted fashion, on the more significant integration error types in embodiments of the system.

One development of embodiments of the invention makes provision for the functional assessment of the system to depend on the respective priority values of the integration errors found. In other words, the integration errors in the system-specific integration error taxonomy are assigned the respective priority values. The priority values may depend on different factors, such as for example the frequency of occurrence of the integration error, the impact of the integration error on embodiments of the system, and the likelihood of it occurring. A higher priority value of a found integration error may mean that the functionality of embodiments of the system is likely to be affected and/or is affected to a relatively large extent by the integration error. A lower priority, on the other hand, may indicate that the integration error has less impact on embodiments of the system, and therefore the functionality of embodiments of the system is hardly affected and/or is affected to a relatively small extent by the integration error. If for example relatively few integration errors are found, each of which is also assigned low priority values, the assessment of embodiments of the system may determine that the system is almost fully functional. A single identified integration error in embodiments of the system to which a relatively high priority value is assigned, by contrast, may cause embodiments of the system to be assessed as non-functional. This development provides that advantage that an impact of an integration error on functionality is able to be assessed better.

One development of embodiments of the invention makes provision for the method to comprise receiving an updated basic integration error taxonomy and/or an updated list by way of the test device. In other words, the test device is provided with the updated basic integration error taxonomy. The test device is configured to update the basic integration error taxonomy stored in the test device with the updated basic integration error taxonomy. By way of example, provision may be made for an assignment of the integration error types to be changed or the basic integration error taxonomy to be supplemented with further integration error types. In addition, and/or as an alternative, embodiments of the method comprise receiving the updated application list by way of the test device. In other words, the test device is provided with the list of integration error detection methods. Provision may be made for the updated list to comprise new or modified integration error detection methods. The test device is configured to update the assignment of the integration error types to the integration error detection methods based on the updated integration error taxonomy and/or the updated list. This provides the advantage of being able to provide new insights into integration errors that occur or new integration error detection methods for performing the examination.

One development of embodiments of the invention makes provision for the system-specific integration error taxonomy to be updated based on the updated basic integration error taxonomy. By way of example, provision may be made for the basic integration error taxonomy to be provided with new integration error types or new integration error detection methods, which may necessitate updating of the system-specific integration error taxonomy. The system-specific integration error taxonomy may accordingly be regenerated based on the updated basic integration error taxonomy.

A further aspect of embodiments of the invention relates to a test device. The test device is configured to perform a method according to the first aspect of embodiments of the present invention.

The presented method is in particular essentially a computer-implemented method. Therefore, a further aspect of embodiments of the invention relates to a computer program product (non-transitory computer readable storage medium having instructions, which when executed by a processor, perform actions) containing program code means that cause an electronic computing device to perform a method according to the first aspect when the program code means are executed by the electronic computing device.

Embodiments of the invention likewise relate, as a further aspect, to a computer-readable storage medium containing the computer program product according to a further aspect.

A computing unit/electronic computing device may be understood to mean in particular a data processing device containing a processing circuit. The computing unit may thus in particular process data in order to perform computing operations. This may possibly also include operations for performing indexed access operations to a data structure, for example a look-up table (LUT).

The computing unit may in particular contain one or more computers, one or more microcontrollers and/or one or more integrated circuits, for example one or more application-specific integrated circuits (ASIC), one or more field-programmable gate arrays (FPGA), and/or one or more systems-on-a-chip (SoC). The computing unit may also contain one or more processors, for example one or more microprocessors, one or more central processing units (CPU), one or more graphics processing units (GPU) and/or one or more signal processors, in particular one or more digital signal processors (DSP). The computing unit may also contain a physical or virtual group of computers or other ones of the stated units.

In various exemplary embodiments, the computing unit contains one or more hardware and/or software interfaces and/or one or more memory units.

A memory unit may be designed as a volatile data memory, for example as a dynamic random access memory (DRAM) or a static random access memory (SRAM), or as a non-volatile data memory, for example as a read-only memory (ROM), as a programmable read-only memory (PROM), as an erasable programmable read-only memory (EPROM), as an electrically erasable programmable read-only memory (EEPROM), as a flash memory or flash EEPROM, as a ferroelectric random access memory (FRAM), as a magnetoresistive random access memory (MRAM) or as a phase-change random access memory (PCRAM).

For application cases or application situations that may arise in a method according to embodiments of the invention and that are not described explicitly here, provision may be made, according to embodiments of the method, for an integration error message and/or a request for input of user feedback to be output and/or a default setting and/or a predetermined initial state to be set.

Irrespective of the grammatical gender of a specific term, persons with male, female or other gender identity are also included.

Further features of embodiments of the invention will become apparent from the claims, the figures and the description of the figures. The features and combinations of features cited above in the description and the features and combinations of features cited below in the description of the figures and/or shown in the figures may be encompassed by embodiments of the invention not just in the respectively specified combination, but also in other combinations. The invention may in particular also encompass embodiments and combinations of features that do not contain all of the features of a claim as originally worded. The invention may moreover encompass embodiments and combinations of features that go beyond or deviate from the combinations of features set out in the back-references in the claims.

### BRIEF DESCRIPTION

Some of the embodiments will be described in detail, with reference to the following figures, wherein like designations denote like members, wherein

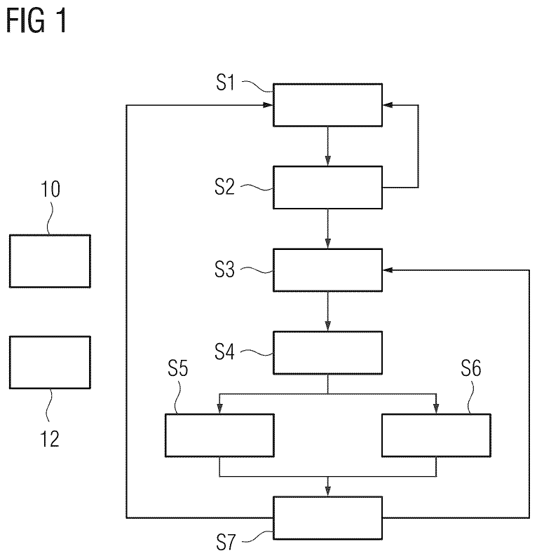

FIG. 1 shows a schematic illustration of a method for identifying integration errors in a system based on a system-specific integration error taxonomy by way of a test device; and

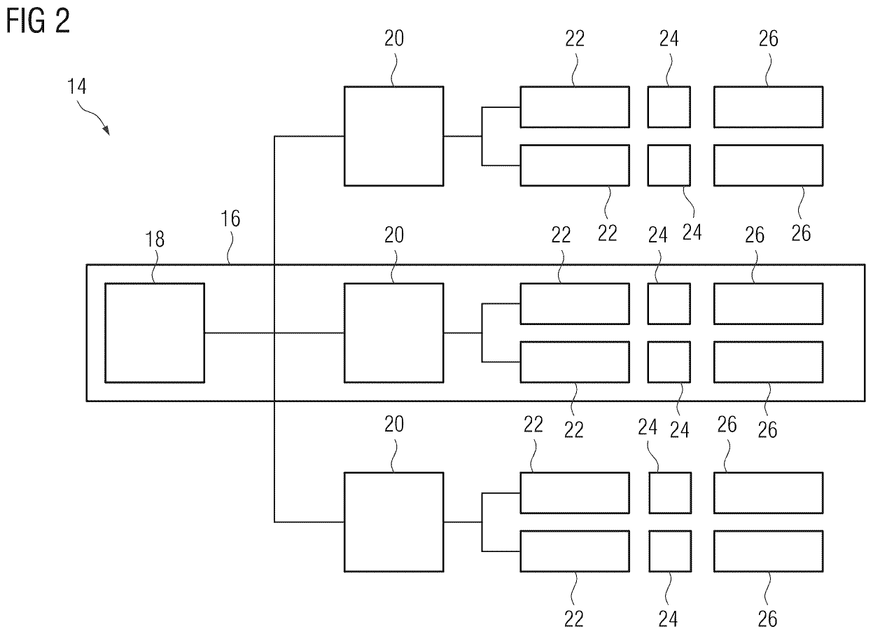

FIG. 2 shows a schematic illustration of a basic integration error taxonomy.

### DETAILED DESCRIPTION

FIG. 1 shows a schematic illustration of a method for identifying integration errors in a system based on a system-specific integration error taxonomy by way of a test device.

A first step of embodiments of the method S1 may comprise providing a basic integration error taxonomy 14 to the test device 10. The basic integration error taxonomy 14 may define integration error classes 20, wherein respective integration error types 22 may be assigned to the respective integration error classes 20. The integration error types 22 and integration error classes 20 may be provided for a multiplicity of different systems 12. In other words, the integration error types 22 may describe integration errors that may occur generally in embodiments of the system 12.

In a second step S2, integration error detection methods 26 may be assigned to the integration errors described in the basic integration error taxonomy 14. In this step, the test device 10 may receive a method list, which may comprise provided integration error detection methods 26. The integration error detection methods 26 may be assigned to respective integration error types 22 identified by the respective integration error detection method 26. In this step, an assignment method is performed, wherein at least some of the integration error types 22 in the basic integration error taxonomy 14 are assigned respective ones of the integration error detection methods 26. In other words, in the assignment method, the basic integration error taxonomy 14 is supplemented with the provided integration error detection methods 26, which may be used to detect the relevant integration error types 22 listed in the basic integration error taxonomy 14.

A third step S3 may comprise creating a system-specific integration error taxonomy 16. In this step, provision may be made for the test device 10 to receive system information describing embodiments of the system 12 to be examined. In embodiments, the system information may for example describe hardware modules and/or software modules of embodiments of the system 12. In this step, provision may also be made for the test device 10 to receive application information describing an application of embodiments of the system 12. Based on the basic integration error taxonomy 14, the test device 10 performs the specialization method, depending on the system information and the application information, wherein the system-specific integration error taxonomy 16 of embodiments of the system 12 to be examined is generated on the basis of the basic integration error taxonomy 14. In embodiments, the system-specific integration error taxonomy 16 likewise comprises integration error classes 20 into which respective integration error types 22 are assigned. However, this is a special integration error taxonomy that is able to be restricted to integration error types 22 that are relevant for embodiments of the system 12. The relevant integration error types 22 are determined by the test device 10 based on embodiments of the system information and the application information. To detect the respective integration error types 22, the test device 10 performs a selection method. The selection method is intended to select the integration error detection methods 26 that are assigned to the respective integration error types 22 in the basic taxonomy, and to assign them to the system-specific integration error taxonomy 16. The integration error detection methods 26 that are suitable for embodiments of the system 12 and the application may be selected here.

A further step comprises examining embodiments of the system 12 in accordance with the system-specific integration error taxonomy 16. As part of examining embodiments of the system 12 in accordance with the system-specific integration error taxonomy 16, it is possible to generate an integration error log describing the integration errors found in embodiments of the system 12 by the integration error detection methods 26. The integration error log may also describe a coverage of embodiments of the system 12 by the examination.

The integration error detection may be carried out in automated fashion by the test device 10 itself, wherein embodiments of the system 12 is able to be examined in accordance with the system-specific integration error taxonomy 16 in accordance with a relevant integration error detection method 26. The examination may also comprise indirect examination methods, wherein instruction signals are output by the test device 10 in accordance with the integration error detection method 26. The instruction signals may for example instruct a further device to examine embodiments of the system 12 or cause an output from the user output. The test device 10 may receive result signals in response to the instruction signals. The result signals may be provided for example to the test device 10 by the further device and describe results of performing the instruction in the instruction signals. The test device 10 may compare the results of the result signals with expected values and identify the presence of an integration error type 22 based on the comparison. In embodiments, the system 12 may be assessed based on the integration error log, wherein an assessment of embodiments of the system 12 is able to be determined depending on the integration error log. Based on the assessment of embodiments of the system 12, it is possible to output an output signal, which may comprise the assessment of embodiments of the system 12. The output signal may be intended for example to enable or disable operation of embodiments of the system 12.

In order to be able to make it possible to modify the basic integration error taxonomy 14 and/or the provided integration error detection methods 26, provision may be made for the test device 10 to be intended to regularly check for the presence of an updated basic integration error taxonomy 14 and to supplement the existing basic integration error taxonomy 14, where applicable, in accordance with the updated basic integration error taxonomy 14. The test device 10 may also be configured to receive an updated method list and to update the provided integration error detection methods 26. Based thereon, the test device 10 may update the assignment of the integration error detection methods 26 to the integration error types 22 in the basic integration error taxonomy 14.

The test device 10 may be configured likewise to update the system-specific integration error taxonomy 16 in the event of a change in the basic integration error taxonomy 14 caused by the update and/or by the updated method list in order to take into account the change in the basic integration error taxonomy 14 and/or the provided integration error detection methods 26. These steps may for example be performed in automated fashion and regularly by the test device 10 in order to enable reliable integration error detection in embodiments of the system 12.

In other words, the described method may be performed as follows: A systematic review of the literature that led to the SOA taxonomy being selected as a base may be performed. The SOA taxonomy may then be adapted by renaming categories, restructuring and adapting subcategories. In the process, new subcategories may be added and existing ones deleted.

The taxonomy may also be adapted based on interviews with experts from the application, wherein the experts may be selected, and the interviews may be conducted and then evaluated. The validated taxonomy may then be finalized by a survey of experts with experience in the field of developing and operating systems with service components.

The output may be a basic integration error taxonomy with a description of the integration error classes.

In a further step, integration error detection and prevention methods may be identified. The basic integration error taxonomy may be used here as input, together with known or available test and prevention methods.

Mapping of integration error classes and test and prevention methods may be carried out, such as for example: service description faults may be determined using syntax checker and contract testing, execution faults may be determined by mutation testing, and composition faults may be determined by API testing.

The output may be an extended version of the basic integration error taxonomy, in which integration error classes are linked to manual or automated integration error detection methods. In addition, it is possible to provide identification of integration error categories without appropriate test/prevention methods and integration troubleshooting and prevention guidance.

The creation of a system-specific taxonomy is an important step in identifying potential risks in embodiments of the system and taking integration error prevention measures. For this purpose, the basic integration error taxonomy may be adapted based on knowledge about embodiments of the system to be tested and the application context. Relevant categories may be selected and prioritized in order to create a system-specific integration error taxonomy. This may provide indications of potential risks and thus provide input for the system design. Integration error detection methods may then be selected based on the system-specific integration error taxonomy (including prioritization). Knowledge about the application context, such as for example target environment, implementation effort and costs, should also be taken into account here. Selecting suitable integration error detection methods makes it possible to create integration error classes using linked methods for manual or automated integration error detection.

Integration errors may be sought manually or in automated fashion, depending on the type of integration error and embodiments of the methods available. For example, a manual approach may be adopted based on checklists, while automated methods may be performed with the aid of tools such as contract testing. It is also possible to select a hybrid approach that combines different methods, depending on the integration error category and available technology. The aim of these steps is to identify prioritized integration error classes as a starting point for targeted testing activities, to find integration error instances and to create a clustered and prioritized overview of integration errors along the integration error taxonomy. Following the integration error detection, the correctness of embodiments of the system may then be assessed. For this purpose, the coverage of the system-specific taxonomy by the test and prevention methods used is first determined, taking into account the priorities and integration error frequencies. A quality assessment may then be derived based on the integration errors found. Overall, this procedure allows an indirect conclusion concerning the degree of correctness/freedom from integration errors of embodiments of the system, which is significantly better than without using an integration error taxonomy. The result is a quality rating of embodiments of the system.

FIG. 2 shows a schematic illustration of a basic integration error taxonomy 14.

A basic integration error taxonomy 14 is a framework for classifying integration errors and faults in complex systems 12, comprising a hierarchical structure consisting of different levels and nodes. This basic integration error taxonomy 14 serves as a basis for the creation of a system-specific integration error taxonomy 16, which is created during the runtime of a system 12 by being adapted to embodiments of the system 12 based on system information and application information.

The basic integration error taxonomy 14 may be divided into different integration error classes 20, which may comprise for example hardware, software and network errors. Each of these integration error classes 20 contains subclasses of integration errors, such as for example memory errors, processor errors and power supply faults for the integration error class 20 of hardware errors. The basic integration error taxonomy 14 also defines various integration error types 22 within each subclass in order to achieve a granular level of integration error classification.

The basic integration error taxonomy 14, according to the assignment method, also comprises various integration error detection methods 26 that are able to be assigned to respective integration error types 22. These integration error detection methods 26 are used to identify and classify potential integration errors of the relevant integration error type 22 in embodiments of the system 12. The integration error detection methods 26 may be linked to the corresponding integration error types 22 in the basic integration error taxonomy 14. The integration error types 22 may also be assigned respective priority values 24. Overall, the basic integration error taxonomy 14 serves as a framework for classifying integration errors in embodiments of the systems 12. The basic integration error taxonomy 14 makes it possible to provide the test device 10 with a standardized method for identifying, classifying and correcting integration errors in embodiments of the system 12, which the test device 10 is able to use as a basis for generating the system-specific integration error taxonomy 16.

The basic integration error taxonomy 14 serves as a starting point for the creation of the system-specific integration error taxonomy 16. In embodiments, the system-specific integration error taxonomy 16 is generated by taking into account the system information and the application information from the basic integration error taxonomy 14. In embodiments, the system-specific integration error taxonomy 16 is created by selecting and prioritizing relevant integration error classes 20 from the basic integration error taxonomy 14 in order to identify potential integration errors in the specific system 12. This is necessary in order to adapt the taxonomy to the specific features of the specific system 12 and to ensure that all relevant integration error classes 20 are taken into account. In embodiments, the system-specific integration error taxonomy 16 thus describes the selection of the suitable integration error detection methods 26 for detecting the integration errors within the context of testing the system 12 and enables a quality assessment of embodiments of the system 12 by virtue of determining a coverage of the system-specific integration error taxonomy 16 by the integration error detection methods 26.

The basic integration error taxonomy 14 shown is able to indicate integration errors that may be related to microservice components.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for identifying integration errors in an integration of service components in a system based on a system-specific integration error taxonomy by way of a test device, wherein the test device stores a basic integration error taxonomy that defines integration error classes, wherein the respective integration error classes are assigned respective integration error types, wherein the method comprises the following steps, to be performed by a test device:
receiving a method list, comprising provided integration error detection methods, wherein the respective integration error detection methods are assigned respective integration error types that are identified by the respective integration error detection method;
performing an assignment method, wherein at least some of the integration error types in the basic integration error taxonomy are assigned respective ones of the integration error detection methods;
receiving system information about the system;
performing a specialization method, wherein a system-specific integration error taxonomy for examining the system depending on the system information is generated based on the basic integration error taxonomy;
performing a selection method, wherein at least some of the integration error types in the system-specific integration error taxonomy are assigned respective ones of the integration error detection methods depending on the system information;
examining the system in accordance with the system-specific integration error taxonomy, and generating an integration error log comprising the integration errors found in the system by the integration error detection methods;
determining a functional assessment of the system depending on the integration error log; and
outputting an output signal comprising the functional assessment of the system.

2. The method as claimed in claim 1, wherein:
the method comprises receiving application information about an application of the system by way of the test device;
the system-specific integration error taxonomy for examining the system in the specialization method is generated depending on the application information;
and at least some of the integration error types in the system-specific integration error taxonomy are assigned, in the selection method, respective ones of the integration error detection methods depending on the application information.

3. The method as claimed in claim 1, wherein the specialization method comprises outputting a notification signal by way of the test device, describing the relevant integration error types in the system-specific integration error taxonomy.

4. The method as claimed in claim 1, wherein examining the system in accordance with at least one of the integration error detection methods comprises the following steps, to be performed by the test device:
outputting an instruction signal comprising instructions for testing and/or operating the system;
receiving a result signal, wherein the result signal comprises results of the performance of the instructions relating to the system;
comparing the results with expected values; and
determining the presence of an integration error based on the comparison of the result with the expected values.

5. The method as claimed in claim 1, wherein examining the system in accordance with least one of the integration error detection methods comprises
controlling the system directly and determining the presence of the integration error.

6. The method as claimed in claim 1, wherein
examining the system comprises the following steps, to be performed by the test device:
determining a coverage of the system-specific integration error taxonomy achieved in the test method;
logging the achieved coverage of the system-specific integration error taxonomy in the integration error log; and
determining the functional assessment of the system depending on the achieved coverage of the system-specific integration error taxonomy.

7. The method as claimed in claim 1, wherein
respective integration error types in the system-specific integration error taxonomy are assigned respective priority values; and
a sequence of the testing of the integration error types in the system-specific integration error taxonomy in the test method depends on the priority values of the integration error types.

8. The method as claimed in claim 1, wherein the functional assessment of the system depends on the respective priority values of the integration errors found.

9. The method as claimed in claim 1, wherein the method comprises the following steps, to be performed by the test device:
receiving an updated basic integration error taxonomy and/or an updated method list; and
updating the assignment of the integration error types to the integration error detection methods based on the updated integration error taxonomy and/or the updated method list.

10. The method as claimed in claim 9, wherein the method comprises updating the system-specific integration error taxonomy.

11. A test device configured to perform a method as claimed in claim 1.

12. A computer program product, comprising a computer readable hardware storage device having computer readable program code stored therein, said program code executable by a processor of a computer system to implement a method as claimed in claim 1 when the program is executed in the electronic computing device.

13. An electronically readable data carrier having electronically readable control information stored thereon, which comprises at least one computer program as claimed in claim 12 and is configured to perform a method when the data carrier is used in an electronic computing device.
